(19) United States
(12) Patent Application Publication
(10) Pub. No.: US 2009/0234924 A1
(43) Pub. Date: Sep. 17, 2009

(54) Automatic Association of Messages with Conversations

(75) Inventors: James J. Edelen, Seattle, WA (US); Jorge Pereira, Seattle, WA (US); Gautam Bhakar, Redmond, WA (US)

Correspondence Address: MERCHANT & GOULD (MICROSOFT), P.O. BOX 2903, MINNEAPOLIS, MN, 55402-0903, US

(73) Assignee: MICROSOFT CORPORATION, Redmond, WA (US)

(21) Appl. No.: 12/048,621

(22) Filed: Mar. 14, 2008

(51) Int. Cl. G06F 15/16; G06F 17/30

(52) U.S. Cl. 709/206; 707/100; 707/E17.045

(57) ABSTRACT

This disclosure describes techniques of automatically associating messages with conversations. As described in this disclosure, when a messaging application stores a message, the messaging application uses a set of heuristics to identify a conversation associated with the message. After identifying the conversation associated with the message, an interface may be presented that group together messages that are associated with common conversations. Such an interface may enable individuals to quickly locate and read messages associated with a conversation.

### BACKGROUND

Email has become an extremely important form of communication. Individuals use email to communicate with friends, family members, colleagues, instructors, and many other parties. One convenient feature of email is the ability to easily write a reply message to a received message. For instance, many email applications include a “reply” or a “reply all” button that automatically populates the header fields of an email message with data appropriate to send the email message back to the sender of an original email message. The receiver of a reply message may then reply to the reply message, and so on. In this way, two or more individuals can use email messages to engage in a conversation.

Individuals store sent and received email messages so that they can subsequently reread their old email messages. In many circumstances, individuals find it difficult to find relevant email messages because of the sheer volume of stored email messages. This problem may be especially acute in the situation where two individuals frequently exchange email messages about a variety of topics. In this situation, simply searching by the name of one of the individuals may not be helpful to identify a desired message because the search would return too many messages. Moreover, in this situation, it may be difficult for an individual to find a reply to an email message because the subject line of the reply message may be different than the subject line of an original message, the reply message may include a different set of recipients than the original message, or the subject line of a reply message and the original message are used in many different conversations. Consequently, a search for a particular subject line or a particular set of recipients may not return the desired reply message or may return too many messages.

Similar problems occur in other types of messages other than email messages. For instance, individuals may encounter similar problems with Short Message Service (SMS) text messages on their mobile telephones or postings on Internet message boards.

### SUMMARY

This disclosure describes techniques of automatically associating messages with conversations. In examples described in this disclosure, when a messaging application stores a message, the messaging application uses a set of heuristics to identify a conversation associated with the message. After identifying the conversation associated with the message, an interface may be presented that group together messages that are associated with common conversations. Such an interface may enable individuals to quickly locate and read messages associated with a conversation.

The techniques of this disclosure may be conceptualized in many ways. For example, the techniques of this disclosure may be conceptualized as a method that comprises storing a plurality of messages. The method also comprises receiving an incoming message. In addition, the method comprises in response to receiving the incoming message, associating the incoming message with an existing conversation when one or more of the following conditions occur: (1) the incoming message includes an “in-reply-to” property that specifies a message identifier that corresponds to a message identifier specified by an “message identifier” property of a stored message associated with the existing conversation; (2) the incoming message includes a “references” property that specifies a message identifier that corresponds to a message identifier specified by a “message identifier” property of a stored message associated with the existing conversation; and (3) a normalized “subject” property of the incoming message corresponds to a normalized “subject” property specified by a stored message associated with the existing conversation.

The techniques of this disclosure may also be conceptualized as a device that comprises a message database that stores a plurality of email messages. The device also comprises an incoming message module that receives an incoming email message. In addition, the device comprises a conversation identification module that sets a “conversation identifier” property of the incoming email message equal to a conversation identifier that identifies an existing conversation when the conversation identification module determines that one or more of the following conditions occur: (1) the incoming email message includes an “in-reply-to” property that specifies a message identifier that corresponds to a message identifier specified by a “message identifier” property of a stored message in the message database that is associated with the existing conversation; (2) the incoming email message includes a “references” property that specifies a message identifier that corresponds to a message identifier specified by a “message identifier” property of a stored email message in the message database that is associated with the existing conversation; and (3) a “subject” property of the incoming email message begins with a relational prefix and a normalized version of the “subject” property corresponds to a normalized version of a “subject” property of a stored email message associated with the existing conversation.

In addition, the techniques of this disclosure may be conceptualized as a computer-readable medium that comprises instructions that cause a computer that executes the instructions to:
1) store a plurality of email messages in a message database;
2) receive an incoming email message;
3) determine whether the incoming email message includes an “in-reply-to” property;
4) determine, when it is determined that the incoming email message includes the “in-reply-to” property, whether the message database stores an email message that includes a “message identifier” property that specifies a message identifier that is equal to a message identifier specified by the “in-reply-to” property of the incoming email message;
5) determine, when it is determined that the message database stores the email message that includes the “message identifier” property that specifies the message identifier that is equal to the message identifier specified by the “in-reply-to” property of the incoming email message, whether the normalized “subject” property of the incoming email message is equal to a normalized “subject” property of the stored email message;
6) determine, when the incoming email message does not include an “in-reply-to” property or when the message database does not store an email message that includes a “message identifier” property that specifies a message identifier that is equal to the message identifier specified by the “in-reply-to” property of the incoming email message, whether the incoming email message includes a “references” property;
7) determine, when it is determined that the incoming email message includes the “references” property, whether the message database stores an email message that includes a “message identifier” property that specifies a message identifier that is equal to a message identifier specified by the “references” property of the incoming email message;
8) determine, when it is determined that the message database stores an email message that includes the “message identifier” property that specifies the message identifier that is equal to the message identifier specified by the “references” property of the incoming email message, whether the normalized “subject” property of the incoming email message is equal to the normalized “subject” property of the stored email message;
9) set, when it is determined that the normalized “subject” property of the incoming email message is equal to the normalized “subject” property of the stored email message, a conversation identifier specified by a “conversation identifier” property of the incoming email message to a conversation identifier specified by a “conversation identifier” property of the stored email message;
10) generate, when it is determined that the normalized “subject” property of the incoming email message is not equal to the normalized “subject” property of the stored email message, a new conversation identifier;
11) determine, either when it is determined that the incoming email message does not include a “references” property or it is determined that the message database does not store the email message that includes the “message identifier” property that specifies the message identifier that is equal to the message identifier specified by the “references” property of the incoming email message, whether the “subject” property of the incoming email message includes a relational prefix;
12) determine, when it is determined that the “subject” property of the incoming email message does not include a relational prefix, whether the incoming email message includes a “conversation identifier” property;
13) determine, either when it is determined that the incoming email message does not include the “conversation identifier” property or when it is determined that the incoming email message does not include the “conversation identifier” property, whether the message database stores an email message that includes a normalized “subject” property that is equal to the normalized “subject” property of the incoming email message;
14) determine, when it is determined that the message database stores an email message that includes a normalized “subject” property that is equal to the normalized “subject” property of the incoming email message and either when it is determined that the incoming email message does not include the “conversation identifier” property or when it is determined that the incoming email message does not include the “conversation identifier” property, whether the stored email message includes a “date” property that indicates that the stored email message was sent within a relevant timeframe;
15) set, when it is determined that the stored email message includes the “date” property that indicates that the stored email message was sent within the relevant timeframe, the “conversation identifier” property of the incoming email message to a conversation identifier specified by the “conversation identifier” property of the stored email message;
16) determine, either when it is determined that the stored email message does not include the “date” property that indicates that the stored email message was sent within the relevant timeframe, whether the incoming email message includes the “conversation identifier” property;
17) generate, when it is determined that the incoming email message does not include the “conversation identifier” property and when it is determined that either the message database does not include an email message that specifies a normalized “subject” property that is equal to the normalized “subject” property of the incoming email message or the “date” property of the stored email message indicates that the stored email message was not sent within the relevant timeframe, the new conversation identifier;
18) set, after the new conversation identifier is generated, the conversation identifier specified by the “conversation identifier” property of the incoming email message equal to the new conversation identifier;
19) store, when it is determined that the incoming email message includes the “conversation identifier” property, the incoming email message in the message database;
20) store, after the value specified by the “conversation identifier” property of the incoming email message is set, the incoming email message in the message database;
21) receive, from a client device that presents an interface that groups email messages associated with common conversations, a request to retrieve email messages in the message database; and
22) send, in response to the request, the email messages in the message database.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram illustrating an example communication system in which messages are automatically associated with conversations.

FIG. 2 is a block diagram illustrating example details of a messaging server in the example communication system of FIG. 1.

FIG. 3 is a flowchart illustrating a general operation of the messaging server of FIG. 2.

FIG. 4A is a flowchart illustrating a first part of an example operation of a conversation identification module in the example messaging server of FIG. 2.

FIG. 4B is a flowchart illustrating a second part of the example operation of the conversation identification module in the example messaging server of FIG. 2.

FIG. 5 is a flowchart illustrating an example operation of an outgoing message module in the example messaging server of FIG. 2.

### DETAILED DESCRIPTION

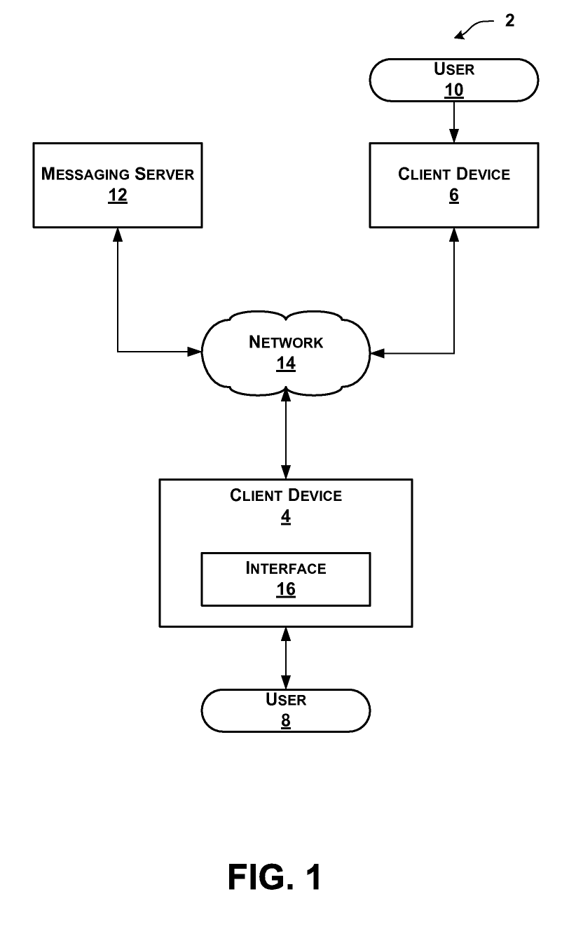

FIG. 1 is a block diagram illustrating an example communication system 2 in which messages are automatically associated with conversations. It should be appreciated that FIG. 1 is provided for explanatory purposes only and is not intended to represent a sole means of implementing the techniques of this disclosure. Rather, the techniques of this disclosure may be implemented in many other ways.

As illustrated in the example of FIG. 1, communication system 2 includes a client device 4 and a client device 6. Client device 4 and client device 6 may be examples of wide variety of devices. For example, client device 4 and/or client device 6 may be personal computers, mobile telephones, personal media players, smart phones, television set-top boxes, personal digital assistants, devices integrated into vehicles, mainframe computers, computer workstations, standalone servers, server blades, server farms, or one or more other types of devices. As illustrated in the example of FIG. 1, a user 8 uses client device 4 and a user 10 uses client device 6.

Furthermore, in the example of FIG. 1, communication system 2 includes a messaging server 12. Messaging server 12 may be one of several types of devices or collections of devices. For instance, messaging server 12 may be a standalone server, a blade server, a server cluster, a server farm, or otherwise.

In the example of FIG. 1, communication system 2 includes a network 14 that facilitates communication between client device 4, client device 6, and messaging server 12. Network 14 may be one of many different types of network. For instance, network 14 may be a local area network, a wide area network (e.g., the Internet), a global area network, a metropolitan area network, or another type of network. Network 14 may include many network devices and many network links. The network devices in network 14 may include bridges, hubs, switches, firewalls, routers, load balancers, and other types of network devices. The network links in network 14 may include wired links (e.g., coaxial cable, fiber optic cable, 10BASE-T cable, 100BASE-TX cable, etc.) and may include wireless links (e.g., WiFi links, WiMax links, wireless broadband links, mobile telephone links, Bluetooth links, infrared links, etc.).

Messaging server 12 may execute a messaging server application that enables users to receive messages and to send messages to other users. In one implementation, the messaging server application may be an instance of a mail transfer agent. Example mail transfer agents include, but are not limited to, Microsoft Exchange servers, sendmail servers, Postfix servers, and Exim servers. In other implementations, the messaging server application may be a Short Message Service (SMS) gateway application, or another type of messaging server application. Nevertheless, for ease of explanation, the remainder of this disclosure is explained with the assumption that messaging server 12 executes a mail transfer agent that enables users to send and receive email messages.

Client device 4 and client device 6 execute instances of a messaging client application. Users 8 and 10 may use the instances of the messaging client application to send and receive email messages. When user 10 uses client device 6 to send an email message to an email address associated with user 8, messaging server 12 directly or indirectly receives the email message. Messaging server 12 may store the email message from user 10 at least until the instance of the messaging client application on client device 4 retrieves the email message from messaging server 12. When user 8 uses client device 4 to send an email message, the instance of the messaging client application executing on client device 4 may send the email message to messaging server 12. Messaging server 12 may then forward the email message to another server executing a mail transfer agent.

Client device 4 may present an interface 16. Interface 16 may be a graphical user interface, a web interface, a command line interface, or another type of user interface. User 8 may use interface 16 to identify email messages that form a conversation. As used in this disclosure, a “conversation” may be conceptualized as a directed acyclic graph in which each node represents an email message and each edge represents a “reply” relationship, a “forward” relationship, a “carbon copy” relationship, or a “blind carbon copy” relationship. User 8 may want to identify email messages that form a conversation for a variety of reasons. For instance, a user may want to identify email messages that form a conversation so that the user may easily trace the progression of an idea being discussed. In another instance, a user may want to identify email messages that form a conversation so that the user can easily find an email message that acknowledges an earlier email message.

However, client device 4 may receive a large number of email messages from many different sources, including client device 6. Because of the large number of email messages received by client device 4, it may be difficult for the user of client device 4 to manually identify email messages that form a conversation. To ease the burden of manually identifying email messages that form a conversation, messaging server 12 may implement techniques that automatically identify email messages that form conversions. Interface 16 may group together email messages that are associated with common conversations.

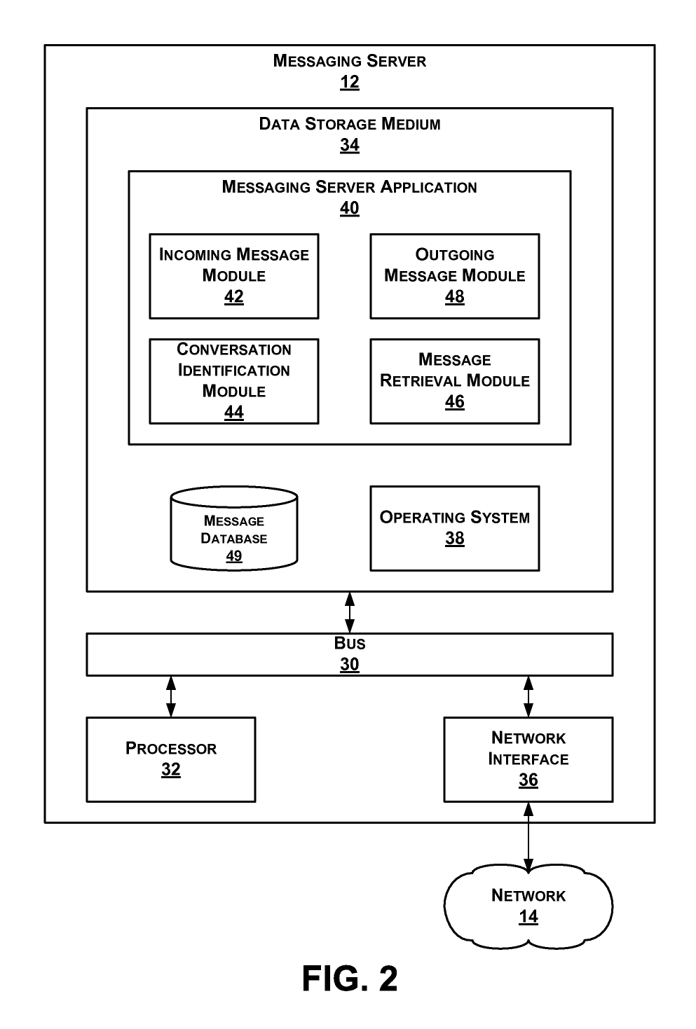

As described in detail with respect to FIGS. 2-5, when messaging server 12 receives an incoming email message, messaging server 12 executes an algorithm that associates the incoming email message with an existing conversation when one or more of the following conditions occur:
(1) The incoming email message includes an “in-reply-to” property that specifies a value that corresponds to a value specified by a “message identifier” property of a stored message associated with the existing conversation;
(2) The incoming email message includes a “references” property that specifies a value that corresponds to a value specified by a “message identifier” property of a stored message associated with the existing conversation; and
(3) A normalized “subject” property of the incoming email corresponds to a normalized “subject” property of a stored message associated with the existing conversation.
   The occurrence of one of these conditions may be minimum preconditions for allowing messaging server 12 to associate the incoming email message with an existing conversation. However, there may be implementations in which additional conditions must occur before messaging server 12 associates the incoming email message with an existing conversation. For instance, one implementation may associate a received message with an existing conversation when condition (2) occurs only if condition (1) does not occur.

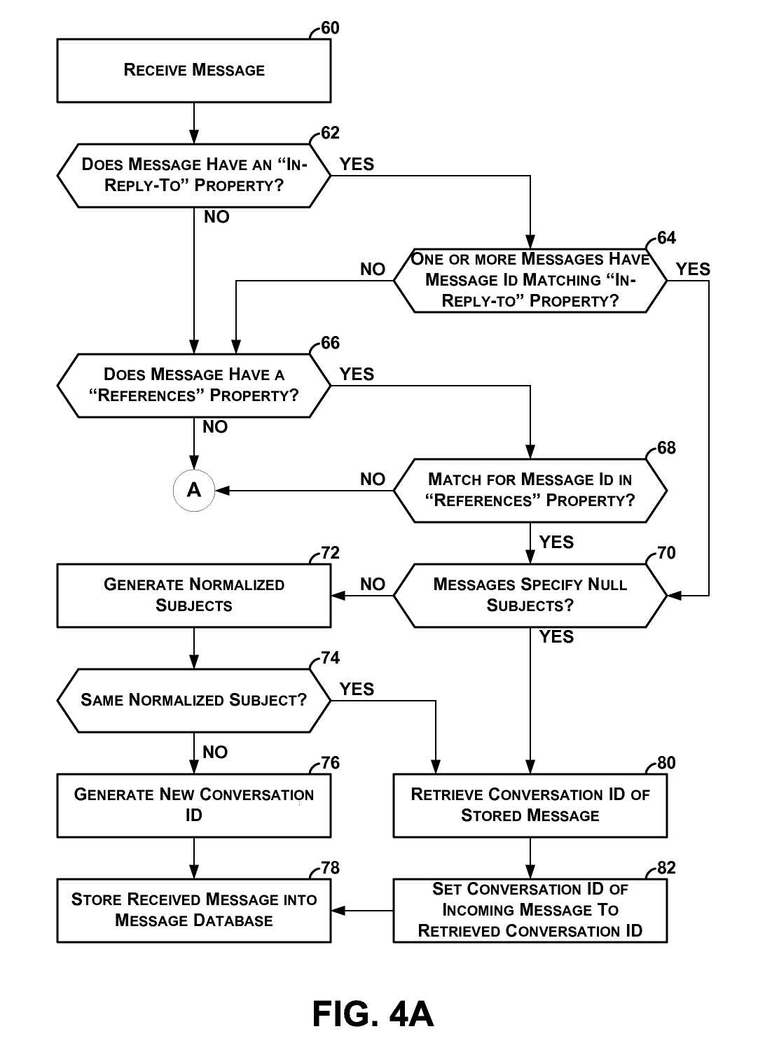

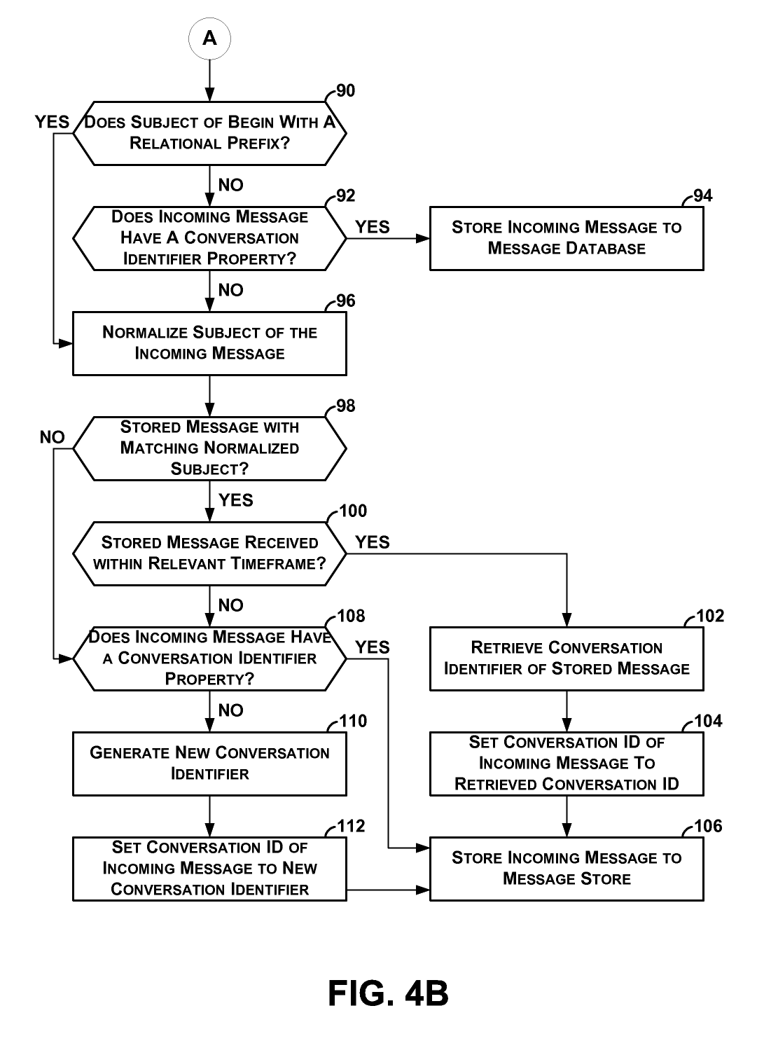

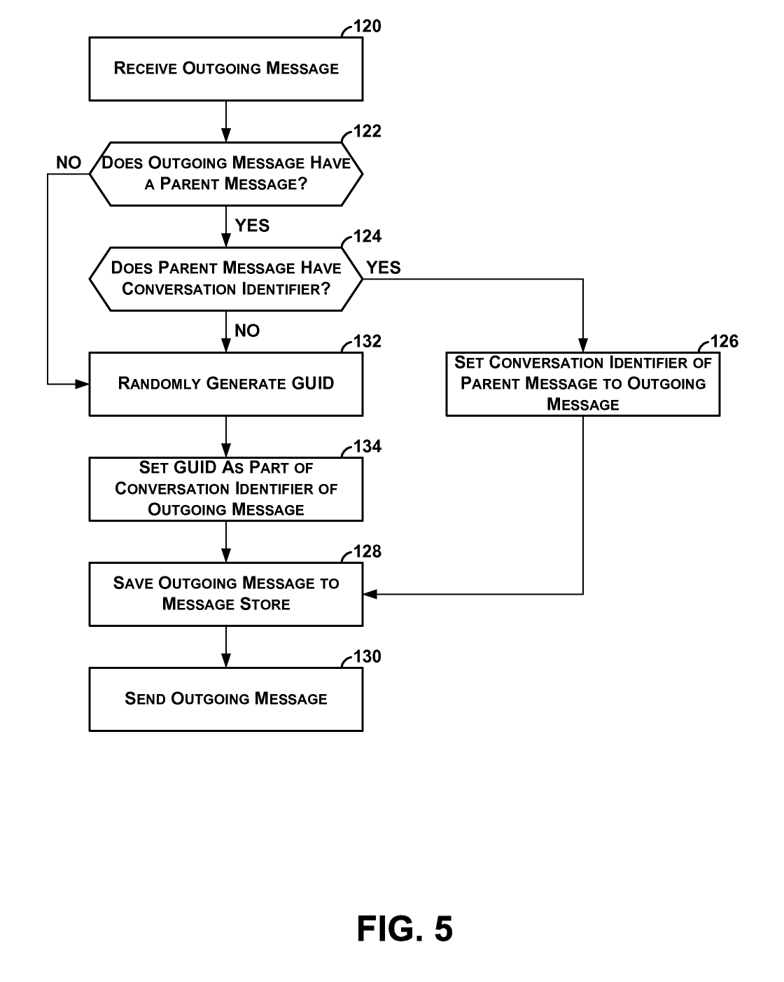

In alternate implementations of communication system 2, messaging server 12 does not act to associate email messages with conversations. Rather, client device 4 may perform actions to associate email messages with conversations. For instance, client device 4 may perform the example operations illustrated in FIGS. 4A and 4B to associate incoming email messages with conversations. In addition, client device 4 may perform the example operation illustrated in FIG. 5 to associate outgoing email messages with conversations.

FIG. 2 is a block diagram illustrating example details of messaging server 12. FIG. 2 is provided for explanatory purposes and is not meant to represent a sole way of implementing messaging server 12. Furthermore, for ease of understanding, actual implementations of messaging server 12 may include many additional features that are not illustrated in the example of FIG. 2. For instance, an actual implementation of messaging server 12 would include a power distribution system, a cooling system, and so on.

As illustrated in the example of FIG. 2, messaging server 12 includes a bus 30 that facilitates data communication between a processor 32, a data storage medium 34, and a network interface 36. For instance, bus 30 may be a HyperTransport bus, an InfiniBand bus, a peripheral component interconnect (PCI) express bus, a universal serial bus (USB), or another type of bus.

In the example of FIG. 2, data storage medium 34 represents a logical collection of one or more volatile and/or non-volatile data storage media that are capable of storing data, including software instructions and application data. For instance, data storage medium 34 may represent one or more magnetic disks, optical discs, flash memory units, dynamic random access memory (RAM) units, RamBus RAM units, synchronous dynamic RAM units, or other types of data storage media.

Processor 32 is an integrated circuit that is capable of executing instructions. For example, processor 32 may be a microprocessor, an application-specific integrated circuit, a digital signal processor, a graphics processing unit, or another type of integrated circuit that is capable of executing instructions. For instance, processor 32 may be a Core processor manufactured by Intel Corporation of Santa Clara, Calif., or a K10 processor manufactured by Advanced Micro Devices, Inc. of Sunnyvale, Calif. Although not illustrated in the example of FIG. 2, messaging server 12 may include several such processors. Processor 32 may read data stored in data storage medium 34 by retrieving the data via bus 30. Moreover, processor may write data to data storage medium 34 by sending the data to data storage medium 34 via bus 30.

Network interface 36 enables messaging server 12 to send data on network 14 and to receive data from network 14. For instance, network interface 36 may be an Ethernet network interface, a token ring network interface, a fiber optic network interface, a WiFi network interface, a WiMax network interface, or another type of wired or wireless network interface. When network interface 36 receives data from network 14, network interface 36 may store the data in data storage medium 34 by sending the data to data storage medium 34 via bus 30. Furthermore, processor 32 may send data via bus 30 to network interface 36 for transmission on network 14.

As illustrated in the example of FIG. 2, data storage medium 34 stores an operating system 38. For instance, data storage medium 34 may store a WINDOWS SERVER® operating system or a WINDOWS VISTA® operating system from Microsoft Corporation, a UNIX operating system, an Apple OS X® operating system, a Linux operating system, or another type of operating system. When executed by processor 32, operating system 38 manages the sharing of resources of messaging server 12 and provides interfaces that other software applications can use to access those resources. For instance, a software application can use an interface provided by operating system 38 to send data through network interface 36 to network 14.

Furthermore, as illustrated in the example of FIG. 2, data storage medium 34 stores a messaging server application 40. When executed by processor 32, messaging server application 40 receives incoming email messages from network 14 and sends outgoing email messages to other messaging servers via network 14.

Messaging server application 40 may be subdivided into an incoming message module 42, a conversation identification module 44, a message retrieval module 46, and an outgoing message module 48. It should be appreciated that incoming message module 42, conversation identification module 44, message retrieval module 46, and outgoing message module 48 may share one or more common instructions. Furthermore, it should be appreciated that messaging server application 40 may include other modules in addition to incoming message module 42, conversation identification module 44, message retrieval module 46, and outgoing message module 48 and provide functionality in addition to the functionality provided by incoming message module 42, conversation identification module 44, message retrieval module 46, and outgoing message module 48. For instance, messaging server application 40 may include a module that filters out “spam” email messages.

When executed by processor 32, incoming message module 42 interacts with operating system 38 to receive incoming email messages that are received from network 14 by network interface 36. For instance, incoming message module 42 may use an interface provided by operating system 38 to configure a callback that causes operating system 38 to provide incoming email messages to incoming message module 42. When incoming message module 42 receives an incoming email message, incoming message module 42 may perform one or more email processing operations on the incoming email message. For instance, incoming message module 42 may determine whether the incoming email address includes a “to” property, a “cc” property, or a “bcc” property that specifies an email address associated with an active account maintained by messaging server 12. In this example, incoming message module 42 may generate an outgoing “bounce” message when the “to” property, the “cc” property, or the “bcc” property of the incoming email message specifies an email address associated with an inactive account that was previously maintained by messaging server 12. After incoming message module 42 performs the email processing operations on the incoming email message, incoming message module 42 may provide the incoming email message to conversation identification module 44.

When executed by processor 32, conversation identification module 44 receives incoming email messages from incoming message module 42 and attempts to identify an existing conversation associated with the incoming email message. If conversation identification module 44 cannot successfully identify an existing conversation associated with the incoming email message, conversation identification module 44 may associate the incoming email message with a new conversation. An example operation of conversation identification module 44 to associate the incoming email message with a conversation is provided with reference to FIGS. 4A and 4B, below.

After conversation identification module 44 associates the incoming email message with an existing conversation or associates the incoming email message with a new conversation, conversation identification module 44 may store in a message database 49 the incoming email message along with a conversation identifier that identifies the conversation associated with the incoming email message. In one implementation, message database 49 includes a table that includes a row for each email message and a column for each property of an email message. For instance, the table may include a column for a “to” property of an email message, a “from” property of the email message, a “cc” property of the email message, a “date” property of the email message, a “subject” property of the email message, a “body” property of the email message, and so on. Furthermore, in this instance, the table may include a column for a conversation identifier that identifies the conversation associated with the email message. An example table is provided below.

TABLE 1

| | | | | Conversation | |
|---|---|---|---|---|---|
| To | From | Subject | Body | Identifier | . . . |
| jones@Microsoft.com | smith@microsoft.com | Atlanta Office | The Atlanta | 53713 | |
| | | Closed | Office is closing | | |
| | | | today . . . | | |
| ybara@Microsoft.com | barney@microsoft.com | Lunch today? | Want to get | 25415 | |
| | | | lunch at noon . . . | | |
| barney@Microsoft.com | ybara@microsoft.com | RE: Lunch | Sure, where do | 25415 | |
| | | today? | you want to go? | | |
| ybara@Microsoft.com | barney@microsoft.com | RE: RE: Lunch | Let's go to | 25415 | |
| | | today? | Mario's . . . | | |
| . . . | . . . | . . . | . . . | . . . | |

It should be appreciated that the table may include columns for many other properties of email messages. These other properties may include an “X-MimeOLE” property, a “Content-class” property, a “MIME-Version” property, a “Content-Type” property, a “Content-Transfer-Encoding” property, a “Date” property, a “Message-ID” property, an “X-MS-Has-Attach” property, a “X-MS-TNEF-Correlator” property, an “X-Priority” property, a “Priority” property, an “Importance” property, a “cc” property, a “bcc” property, and so on. Furthermore, it can easily been seen that Table 1 includes a series of email messages exchanged between a person associated with the email address “ybara@microsoft.com” and a person associated with the email address “barney@microsoft.com” regarding whether to get lunch. It should be noted that these email messages have the same conversation identifier listed in their “conversation identifier” properties. In this way, the conversation identifiers of the “conversation identifier” properties of these email messages indicate that these email messages are associated with a common conversation.

When executed by processor 32, message retrieval module 46 enables users to retrieve email messages stored in message database 49. For example, message retrieval module 46 may receive periodic requests from a message client application on client device 4 to retrieve new messages that specify an email address associated with user 8. In response to such requests, message retrieval module 46 may identify any new email messages in message database 49 that have not previously been sent to client device 4. If message retrieval module 46 identifies any such new email messages, message retrieval module 46 may send the identified email messages, along with the conversation identifiers of the email messages, to client device 4. Upon receiving the identified email messages, the messaging client application on client device 4 may present interface 16 in which the identified email messages, along with previously retrieved email messages, are grouped by conversation with which the email messages are associated. For instance, client device 4 may present an interface in which email messages that are associated with a conversation are presented as trees of email messages. In another instance, client device 4 may present an interface that includes separate lists of email messages for each conversation.

When executed by processor 32, outgoing message module 48 enables users to send outgoing email messages. For example, outgoing message module 48 may receive a request from the messaging client application on client device 4 to send an outgoing email message. In this example, outgoing message module 48 may associate the outgoing email message with a conversation identifier and incorporate this conversation identifier into the outgoing email message. An example operation whereby outgoing message module 48 associates the outgoing email message with a conversation identifier is provided with reference to FIG. 5, below. After outgoing message module 48 associates the outgoing email message with the conversation identifier and incorporates this conversation identifier into the outgoing email message as a “conversation identifier” property of the email message, outgoing message module 48 may instruct operating system 38 to send the outgoing email message on network 14.

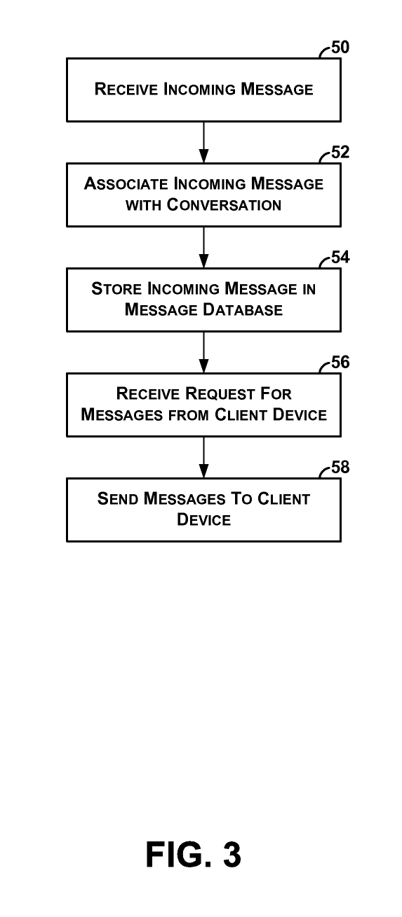

FIG. 3 is a flowchart illustrating an example operation of messaging server 12. In the example of FIG. 3, incoming message module 42 receives an incoming email message (50). After incoming message module 42 receives the incoming email message, conversation identification module 44 associates the incoming email message with a conversation (52). Conversation identification module 44 may then store the incoming email message in message database 49 (54). In this way, as incoming message module 42 continues to receive incoming email messages and conversation identification module 44 continues to store the incoming email messages in message database 49, message database 49 eventually stores a plurality of email messages.

Subsequently, message retrieval module 46 may receive, from a messaging client application executing on client device 4, a request for email messages stored in message database 49 (56). In response to the request, message retrieval module 46 may send email messages that specify an email address associated with a user of client device 4 to client device 4 (58). The email client application executing on client device 4 may present interface 16 that groups email messages associated with common conversations.

FIG. 4A is a flowchart illustrating a first part of an example operation of conversation identification module 44. Initially, conversation identification module 44 receives an incoming email message from incoming message module 42 (60). After conversation identification module 44 receives the incoming email message, conversation identification module 44 may determine whether the incoming email message has an “in-reply-to” property (62). In general, the “in-reply-to” property of a first email message specifies a message identifier of a second email message to which the first email message is a reply. Because the “in-reply-to” property of the first email message explicitly specifies the message identifier of the second message, it may be possible to associate the first email message with the same conversation as the second email message. However, the “in-reply-to” property is described in Internet Engineering Task Force (IETF) Request for Comment (RFC) 822 and IETF RFC 2822 as an optional property of email messages. Consequently, many email server applications and email client applications do not utilize the “in-reply-to” property. For this reason, the “in-reply-to” properties may not be exclusively relied upon to associate email messages with conversations.

If the incoming email message includes an “in-reply-to” property (“YES” of 62), conversation identification module 44 determines whether message database 49 stores any email messages that include a “message identifier” property that specifies a message identifier that matches the message identifier specified in the “in-reply-to” property of the incoming email message (64).

If message database 49 does not store any email messages that include a “message id” property that specifies a message identifier that matches the message identifier specified in the “in-reply-to” property of the incoming email message (“NO” of 64) or if the incoming email message does not include an “in-reply-to” property (“NO” of 62), conversation identification module 44 may determine whether the incoming email message includes a “references” property (66). In general, a “references” property of an email message specifies message identifiers of other email message that the email message references. For instance, a “references” property of an email message may contain the content of the “references” field of the email message's parent email message. IETF RFC 822 and IETF RFC 2822 describe usage of the “references” property. Furthermore, IETF RFC 822 and IETF RFC 2822 describe the “references” property, like the “in-reply-to” property, as an optional property of email messages. Consequently, many email server applications and email client applications do not utilize the “references” property.

If the incoming email message does not include a “references” property (“NO” of 66), conversation identification module 44 may perform the second part of the operation as illustrated in the example of FIG. 4B.

However, if the incoming email message does include a “references” property (“YES” of 66), conversation identification module 44 may determine whether message database 49 stores an email message that specifies a “message identifier” property that specifies a message identifier that matches a message identifier specified in the “references” property of the incoming email message (68). If message database 49 does not store an email message that includes a “message identifier” property that specifies a message identifier that matches a message identifier specified in the “references” property of the incoming email message (“NO” of 68), conversation identification module 44 may perform the second part of the operation as illustrated in the example of FIG. 4B.

If message database 49 stores an email message that includes a “message identifier” property that specifies a message identifier that matches a message identifier specified in the “references” property of the incoming email message (“YES” of 68) or if conversation identification module 44 determines that message database 49 stores an email message that includes a “message identifier” property that specifies a message identifier that matches the value specified in the “in-reply-to” property of the incoming email message (“YES” of 64), conversation identification module 44 determines whether the “subject” properties of the incoming email message and the stored email message specify null values (70). Conversation identification module 44 determines whether the “subject” property of incoming email message specifies a null value because it is likely that a large number of unrelated email messages have “subject” properties that specify null values.

If conversation identification module 44 determines that the “subject” properties of the incoming email message and the stored email message do not specify null values (“NO” of 70), conversation identification module 44 may generate normalized “subject” properties for the incoming email message and the stored email message (72). A “subject” property of an email message is normalized when the “subject” property of the email message is stripped of any relational prefixes that indicate reply or forward (e.g., “RE:” or “FW:”). For example, if the “subject” property of the incoming email message is “RE: RE: Lunch today?” and the “subject” property of the stored email message is “RE: Lunch today?” the normalized “subject” property of the incoming email message is “Lunch today?” and the normalized “subject” property of the stored email message is “Lunch today?”. When conversation identification module 44 generates the normalized “subject” properties, conversation identification module 44 may not permanently change the “subject” properties of the incoming email message and the stored email message.

After generating the normalized “subject” properties of the incoming email message and the stored email message, conversation identification module 44 may determine whether the normalized “subject” property of the incoming email message is the same as the normalized “subject” property of the stored email message (74). Conversation identification module 44 may use simple textual comparison to determine whether the normalized “subject” property of the incoming email message is the same as the normalized “subject” property of the stored email message.

If the normalized “subject” property of the incoming email message is not the same as the normalized “subject” property of the stored email message (“NO” of 74), conversation identification module 44 may generate a new conversation identifier (76). When conversation identification module 44 generates the new conversation identifier, conversation identification module 44 may generate the new conversation identifier as a globally unique identifier (GUID). For instance, conversation identification module 44 may apply a hash function to the incoming email message, including all properties of the incoming email message. The hash function may output a value that is different than values outputted by the hash function for almost all other possible email messages. After conversation identification module 44 generates the new conversation identifier, conversation identification module 44 may store the incoming email message, along with the new conversation identifier, into message database 49 (78).

On the other hand, if the normalized “subject” property of the incoming email message is the same as the normalized “subject” property of the stored email message (“YES” of 74) or if the “subject” properties of the incoming email message and the stored email message specify null values (“YES” of 70), conversation identification module 44 may retrieve the conversation identifier of the stored email message from message database 49 (80). After retrieving the conversation identifier of the stored email message from message database 49, conversation identification module 44 may set the “conversation identifier” property of the incoming email message to the conversation identifier specified by the “conversation identifier” property of the stored email message (82). Next, conversation identification module 44 may store the incoming email message, along with its conversation identifier, into message database 49 (78).

FIG. 4B is a flowchart illustrating a second part of the example operation of conversation identification module 44. Initially, in the second part of the example operation, conversation identification module 44 determines whether the “subject” property of the incoming email message begins with a relational prefix that indicates that the incoming email message is a reply to or a forward of another message (90). For example, conversation identification module 44 may determine whether the “subject” property of the incoming email message begins with one or more instances of “RE:” or “FW:”.

If the “subject” property of the incoming email message does not begin with such a relational prefix (“NO” of 90), conversation identification module 44 may determine whether the incoming email message includes a “conversation identifier” property (92). If the incoming email message includes a “conversation identifier” property (“YES” of 92), conversation identification module 44 may store the incoming email message, along with its “conversation identifier” property, to message database 49 (94).

Otherwise, if the incoming email message does not include a “conversation identifier” property (“NO” of 92) or if the incoming email message begins with a relational prefix (“YES” of 90), conversation identification module 44 may normalize the “subject” property of the incoming email message (96). As discussed above, a “subject” property of an email message is normalized when the “subject” property of the email message is stripped of any relational prefixes that indicate reply or forward (e.g., “RE:” or “FW:”).

After normalizing the “subject” property of the incoming email message, conversation identification module 44 may determine whether message database 49 stores an email message that has a normalized “subject” property that matches the normalized “subject” property of the incoming email message (98). If message database 49 stores an email message that has a normalized “subject” property that matches the normalized “subject” property of the incoming email message (“YES” of 98), conversation identification module 44 may determine whether the “date” property of the stored email message indicates that the stored email message was sent within a relevant timeframe (100). The relevant timeframe is a timeframe within which it is most likely that the incoming email message and the stored email message are likely associated with the same conversation. For example, conversation identification module 44 may determine that the “date” property of the stored email message indicates that the stored email message was sent within a relevant timeframe when the “date” property of the stored email message indicates that the stored email message was sent within 72 hours of the time indicated by the “date” property of the incoming email message.

If the “date” property of the stored email message indicates that the stored email message was sent within a relevant timeframe (“YES” of 100), conversation identification module 44 may retrieve the conversation identifier specified by the “conversation identifier” property of the stored email message (102). Conversation identification module 44 may then set the “conversation identifier” property of the incoming email message to the conversation identifier specified by the “conversation identifier” property of the stored email message (104). Next, conversation identification module 44 stores the incoming email message, along with its “conversation identifier” property, to message database 49 (106).

If message database 49 does not store an email message that has a normalized “subject” property that matches the normalized “subject” property of the incoming email message (“NO” of 98) or if the “date” property of the stored email message indicates that the stored email message was not sent within a relevant timeframe (“NO” of 100), conversation identification module 44 may determine whether the incoming email message includes a “conversation identifier” property (108). If the incoming email message includes a “conversation identifier” property (“YES” of 108), conversation identification module 44 stores the incoming email message, along with its “conversation identifier” property, to message database 49 (106).

If the incoming email message does not include a “conversation identifier” property (“NO” of 108), conversation identification module 44 generates a new conversation identifier (110). After conversation identification module 44 generates the new conversation identifier, conversation identification module 44 sets the value of the “conversation identifier” property of the incoming email message to the new conversation identifier (112). Conversation identification module 44 then stores the incoming email message, along with its “conversation identifier” property, to message database 49 (106).

FIG. 5 is a flowchart illustrating an example operation of outgoing message module 48. In the example of FIG. 5, outgoing message module 48 may initially receive an outgoing email message from a messaging client application executing on client device 4 (120). The outgoing email message may be an original message, a reply message, a forward message, a cc message, and or otherwise.

After receiving the outgoing email message, outgoing message module 48 may determine whether the outgoing email message has a parent email message (122). In one example implementation, outgoing message module 48 may determine that the outgoing email message has a parent because the messaging client application is configured to automatically include a “in-reply-to” property that specifies a message identifier specified by a “message identifier” property of the parent email message when the outgoing email message has a parent email message.

If the outgoing email message has a parent email message (“YES” of 122), outgoing message module 48 may determine whether the parent email message includes a “conversation identifier” property (124). If the outgoing email message includes a “conversation identifier” property (“YES” of 124), outgoing message module 48 may set the “conversation identifier” property of the outgoing email message to the conversation identifier specified by the “conversation identifier” property of the parent email message (126). Outgoing message module 48 may then store the outgoing email message, along with its “conversation identifier” property, to message database 49 (128). Next, outgoing message module 48 may use operating system 38 to send the outgoing email message (130).

On the other hand, if the outgoing email message does not have a parent email message (“NO” of 122) or if the parent email message does not include a “conversation identifier” property (“NO” of 124), outgoing message module 48 may randomly generate a GUID (132). Outgoing message module 48 may then store this GUID as at least part of a conversation identifier specified by the “conversation identifier” property of the outgoing email message (134). Next, outgoing message module 48 may then store the outgoing email message, along with its “conversation identifier” property, to message database 49 (128). After storing the outgoing email message to message database 49, outgoing message module 48 may use operating system 38 to send the outgoing email message (130).

It is to be understood that the embodiments described herein may be implemented by hardware, software, firmware, middleware, microcode, or any combination thereof. When the systems and/or methods are implemented in software, firmware, middleware or microcode, program code or code segments, they may be stored in a machine-readable medium, such as a storage component. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, etc.

For a software implementation, the techniques described herein may be implemented with modules (e.g., procedures, functions, and so on) that perform the functions described herein. The software codes and instructions may be stored in computer-readable media and executed by processors. The memory unit may be implemented within the processor or external to the processor, in which case it can be communicatively coupled to the processor via various means as is known in the art.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, comprising:
storing a plurality of messages;
receiving an incoming message; and
in response to receiving the incoming message, associating the incoming message with an existing conversation when one or more of the following conditions occur:
(1) the incoming message includes an “in-reply-to” property that specifies a message identifier that corresponds to a message identifier specified by a “message identifier” property of a stored message associated with the existing conversation;
(2) the incoming message includes a “references” property that specifies a message identifier that corresponds to a message identifier specified by a “message identifier” property of a stored message associated with the existing conversation; and
(3) a normalized “subject” property of the incoming message corresponds to a normalized “subject” property of a stored message associated with the existing conversation.

2. The method of claim 1,
wherein receiving the incoming message further comprises receiving, at a client device, the incoming message; and
wherein associating the incoming message with the existing conversation further comprises associating, at the client device, the incoming message with the existing conversation when one or more of the conditions (1), (2), or (3) occur.

3. The method of claim 2, further comprising presenting, at the client device, an interface in which the stored messages are grouped by conversation with which the messages are associated.

4. The method of claim 1,
wherein receiving the messaging message further comprises receiving, at a messaging server, the incoming message;
wherein associating the incoming message with the existing conversation further comprises associating, at the messaging server, the incoming message with the existing conversation when one or more of the conditions (1), (2), or (3) occur; and
wherein the method further comprises:
receiving, from a client device that presents an interface that groups messages associated with common conversations, a request to retrieve ones of the stored messages; and
sending, in response to the request, the requested ones of the stored messages.

5. The method of claim 1, wherein the incoming message is an email message.

6. The method of claim 1, wherein, to associate the incoming message with the existing conversation because the incoming message includes an “in-reply-to” property that specifies a message identifier that corresponds to a message identifier specified by the “message identifier” property of the stored message, the stored message includes a “subject” property that specifies a null value or includes a normalized “subject” property that corresponds to the normalized “subject” property of the incoming message.

7. The method of claim 1, wherein, to associate the incoming message with the existing conversation because the incoming message includes a “references” property that specifies a message identifier that corresponds to a message identifier specified by a “message identifier” property of the stored message, the incoming message does not include an “in-reply-to” property that specifies a message identifier that corresponds to a message identifier specified by an “in-reply-to” property of one of the stored messages.

8. The method of claim 1, wherein, to associate the incoming message with the existing conversation because the normalized “subject” property of the incoming message corresponds to the normalized “subject” property specified by the stored message associated with the existing conversation, the incoming message does not:
(1) include an “in-reply-to” property that specifies a message identifier that corresponds to a message identifier specified by a “message identifier” property of one of the stored messages; and
(2) include a “references” property that specifies a message identifier that corresponds to a message identifier specified by a “message identifier” property of one of the stored messages.

9. The method of claim 1, further comprising associating the incoming message with the existing conversation when:
(a) none of the conditions (1), (2), or (3) is true;
(b) the incoming message does not specify a conversation identifier; and
(c) the incoming message specifies a subject that corresponds to a subject property specified by a stored message associated with the existing conversation.

10. The method of claim 1, further comprising:
storing a conversation identifier associated with the existing conversation when the incoming message is associated with the existing conversation; and
storing a conversation identifier associated with a new conversation when the incoming message is not associated with any existing conversation.

11. The method of claim 10, further comprising presenting an interface such that the stored messages and the incoming message are grouped by conversation identifier.

12. The method of claim 1, further comprising:
receiving an instruction to send an outgoing message;
determining whether the stored messages include a parent message of the outgoing message;
determining whether the parent message includes a conversation identifier that specifies a conversation identifier when the stored messages include the parent message;
generating a new conversation identifier when the stored messages do not include the parent message;
storing the conversation identifier specified by the parent message as a “conversation identifier” property of the outgoing message; and
sending the outgoing message.

13. The method of claim 1, wherein the method further comprises associating the incoming message with a new conversation when none of the conditions (1), (2), or (3) occurs.

14. A device, comprising:
a message database that stores a plurality of email messages;
an incoming message module that receives an incoming email message;
a conversation identification module that sets a “conversation identifier” property of the incoming email message equal to a conversation identifier that identifies an existing conversation when the conversation identification module determines that one or more of the following conditions occur:
(1) the incoming email message includes an “in-reply-to” property that specifies a message identifier that corresponds to a message identifier specified by a “message identifier” property of a stored message in the message database that is associated with the existing conversation;
(2) the incoming email message includes a “references” property that specifies a message identifier that corresponds to a message identifier specified by a “references” property of a stored email message in the message database that is associated with the existing conversation; and
(3) a “subject” property of the incoming email message begins with a relational prefix and a normalized version of the “subject” property corresponds to a normalized version of a “subject” property of a stored email message associated with the existing conversation.

15. The device of claim 14, wherein the device is a client device that presents an interface that groups email messages associated with common conversation identifiers.

16. The device of claim 14, wherein the device further comprises a message retrieval module that receives, from a client device that presents an interface that groups email messages associated with common conversations, a request to retrieve email messages in the message database, wherein the message retrieval module sends, in response to the request, the email messages in the message database.

17. The device of claim 14, wherein the device further comprises an outgoing message module that receives an instruction to send an outgoing email message; determines whether the message database include a parent email message of the outgoing email message; determines whether the parent email message includes a “conversation identifier” property that specifies a conversation identifier when the message database includes the parent email message; generates a new conversation identifier when the message database does not include the parent email message; stores the conversation identifier specified by the parent email message as the “conversation identifier” property of the outgoing email message; and sends the outgoing email message.

18. The device of claim 14, wherein the conversation identification module sets the “conversation identifier” property of the incoming email message equal to a conversation identifier that identifies a new conversation when none of the conditions (1), (2), or (3) occurs.

19. A computer-readable medium comprising instructions that cause a computer that executes the instructions to:
store a plurality of email messages in a message database;
receive an incoming email message;
determine whether the incoming email message includes an “in-reply-to” property;
determine, when determined that the incoming email message includes the “in-reply-to” property, whether the message database stores an email message that includes a “message identifier” property that specifies a message identifier that is equal to a message identifier specified by the “in-reply-to” property of the incoming email message;
determine, when determined that the message database stores the email message that includes the “message identifier” property that specifies the message identifier that is equal to the message identifier specified by the “in-reply-to” property of the incoming email message, whether the normalized “subject” property of the incoming email message is equal to a normalized “subject” property of the stored email message;
determine, when the incoming email message does not include an “in-reply-to” property or when the message database does not store an email message that includes a “message identifier” property that specifies a message identifier that is equal to the message identifier specified by the “in-reply-to” property of the incoming email message, whether the incoming email message includes a “references” property;
determine, when determined that the incoming email message includes the “references” property, whether the message database stores an email message that includes a “message identifier” property that specifies a message identifier that is equal to a message identifier specified by the “references” property of the incoming email message;
determine, when determined that the message database stores an email message that includes the “message identifier” property that specifies the message identifier that is equal to the message identifier specified by the “references” property of the incoming email message, whether the normalized “subject” property of the incoming email message is equal to the normalized “subject” property of the stored email message;
set, when determined that the normalized “subject” property of the incoming email message is equal to the normalized “subject” property of the stored email message, a conversation identifier specified by a “conversation identifier” property of the incoming email message to a conversation identifier specified by a “conversation identifier” property of the stored email message;
generate, when determined that the normalized “subject” property of the incoming email message is not equal to the normalized “subject” property of the stored email message, a new conversation identifier;
determine, either when determined that the incoming email message does not include a “references” property or determined that the message database does not store the email message that includes the “message identifier” property that specifies the message identifier that is equal to the message identifier specified by the “references” property of the incoming email message, whether the “subject” property of the incoming email message includes a relational prefix;
determine, when determined that the “subject” property of the incoming email message does not include a relational prefix, whether the incoming email message includes a “conversation identifier” property;
determine, either when determined that the incoming email message does not include the “conversation identifier” property or when determined that the incoming email message does not include the “conversation identifier” property, whether the message database stores an email message that includes a normalized “subject” property that is equal to the normalized “subject” property of the incoming email message;
determine, when determined that the message database stores an email message that includes a normalized “subject” property that is equal to the normalized “subject” property of the incoming email message and either when it is determined that the incoming email message does not include the “conversation identifier” property or when it is determined that the incoming email message does not include the “conversation identifier” property, whether the stored email message includes a “date” property that indicates that the stored email message was sent within a relevant timeframe;
set, when determined that the stored email message includes the “date” property that indicates that the stored email message was sent within the relevant timeframe, the “conversation identifier” property of the incoming email message to a conversation identifier specified by the “conversation identifier” property of the stored email message;
determine, when determined that the stored email message does not include the “date” property that indicates that the stored email message was sent within the relevant timeframe, whether the incoming email message includes the “conversation identifier” property;
generate, when determined that the incoming email message does not include the “conversation identifier” property and when it is determined that either the message database does not include an email message that specifies a normalized “subject” property that is equal to the normalized “subject” property of the incoming email message or the “date” property of the stored email message indicates that the stored email message was not sent within the relevant timeframe, the new conversation identifier;
set, after the new conversation identifier is generated, the conversation identifier specified by the “conversation identifier” property of the incoming email message equal to the new conversation identifier;
store, when determined that the incoming email message includes the “conversation identifier” property, the incoming email message in the message database;
store, after the value specified by the “conversation identifier” property of the incoming email message is set, the incoming email message in the message database;
receive, from a client device that presents an interface that groups email messages associated with common conversations, a request to retrieve email messages in the message database; and
send, in response to the request, the email messages in the message database.

20. The computer-readable medium of claim 19, further comprising instructions that cause the computer to:
receive an outgoing email message;
determine, when the outgoing email message is received, whether the outgoing email message has a parent email message;
determine, when determined that the outgoing email message has a parent email message, whether the parent email message includes a “conversation identifier” property;
set, when determined that the parent email message includes the “conversation identifier” property, a value of a “conversation identifier” property of the outgoing email message to a value specified by the “conversation identifier” property of the parent email message;
randomly generate, when determined that either the outgoing email message does not have a parent email message or the patent email message does not include the “conversation identifier” property, at least a portion of a new conversation identifier;
set, after the portion of the new conversation identifier is generated, the value of the “conversation identifier” property of the outgoing email message to the new conversation identifier;
send, after the value of the “conversation identifier” property of the outgoing email message is set, the outgoing email message.
